(19) United States
(12) Patent Application Publication
(10) Pub. No.: US 2006/0039096 A1
(43) Pub. Date: Feb. 23, 2006

(54) Cover for protecting electrical product from dust

(75) Inventor: Ga-Lane Chen, Fremont, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/207,103

(22) Filed: Aug. 18, 2005

(30) Foreign Application Priority Data
Aug. 20, 2004 (TW) 93125162

(51) Int. Cl. H01H 47/00

(52) U.S. Cl. 361/220

(57) ABSTRACT

A cover protects an electrical product from dust. Preferably, the cover includes a shell, a layer of carbon composition and a layer of nano-catalyst. The shell covers the electrical product. The layer of carbon composition is formed on the shell. The layer of carbon composition includes about 0.1% to about 10% by volume of carbon nanotubes, about 1% to about 10% by volume of carbon nanocapsules, and about 80% to about 98.8% by volume of electrically-conductive carbon black particles. The layer of nano-catalyst is on the layer of carbon composition. The layer of nano-catalyst includes 5% to 90% by volume of TiO₂.

### FIELD OF THE INVENTION

The present invention relates to a cover for an electrical product, and particularly to a cover for protecting a mobile phone from dust.

### BACKGROUND OF THE INVENTION

Dust may comprise extremely small grains of waste matter. Such dust can be carried by breezes from place to place, and may settle on surfaces of electrical products such as mobile phones. The dust may discolor or otherwise impair the appearance of the shell of a mobile phone.

Dust may also move from place to place when it is contained within a flowable medium such as moisture. For example, rainwater incorporating dust may seep through the shell of the mobile phone into the interior. After time, it may become necessary for a user to remove the shell and clean the interior of the mobile phone.

Dust may also harbor microorganisms such as bacteria. Some bacteria cause diseases. Any such dust present on or in a mobile phone is liable to infect the user.

In addition, dust give off unpleasant smells, making it uncomfortable for a user to operate a mobile phone.

What is needed, therefore, is a cover to protect an electrical product such as a mobile phone from dust.

### SUMMARY

A first embodiment provides a cover for protecting an electrical product from dust. Preferably, the cover includes a shell, a layer of a carbon composition and a layer of nano-catalyst. The shell covers the electrical product. The carbon composition layer is formed on the shell. The carbon composition layer includes about 0.1% to about 10% by volume of carbon nanotubes, about 1% to about 10% by volume of carbon nanocapsules, and about 80% to about 98.8% by volume of electrically-conductive carbon black particles. The layer of nano-catalyst is formed on the carbon composition layer. The layer of nano-catalyst includes 5% to 90% by volume of TiO₂.

The carbon composition layer has a thickness in the range of about 100 to about 1000 nanometers, and more preferably about 200 to about 500 nanometers. The layer of nano-catalyst has a thickness in the range of about 10 to about 50 nanometers, and more preferably about 20 to about 40 nanometers. Each of the carbon nanocapsules has a diameter in the range of about 20 to about 100 nanometers. Each of the electrically-conductive carbon black particles has a diameter in the range of about 30 to about 100 nanometers.

The cover may further include a plurality of metal nanograins added in the carbon composition layer, so that the carbon composition layer added with metal nanograins includes about 0.1% to about 10% by volume of the metal nanograins.

The layer of nano-catalyst includes a plurality of metal nanoparticles. Each of the metal nanoparticles has a diameter in the range of about 1 to about 5 nanometers.

In addition to protect the electrical product from dust, the previously described embodiments have many other advantages. First, the carbon nanotubes and the carbon nanocapsules have excellent mechanical properties (high Young's modulus), and are therefore wear resistant. Second, the carbon nanotubes and the carbon nanocapsules have a fine surface structure generating Lotus effect, so that the carbon nanotubes and the carbon nanocapsules are hydrophobic and self-cleaning. Third, the electrically-conductive carbon blacks are more inexpensive than the carbon nanotubes and the carbon nanocapsules, thereby lowering the cost of depositing the layer of carbon composition. Fourth, the layer of carbon composition shields the electrical product from electromagnetic interference, and protects the layer of carbon composition from static charges. Fifth, the metal particles in the layer of nano-catalyst are antiseptic and deodorant.

Other advantages and novel features will be drawn from the following detailed description of preferred embodiments.

### DETAILED DESCRIPTION OF PREFERRED EMBODIMENTS

A first embodiment of this invention provides a cover to protect an electrical product from dust. The electrical product is, for example, a mobile phone. The cover includes a shell, a first layer of a carbon composition, and a second layer of nano-catalyst. The shell covers the electrical product. The carbon composition layer is formed on the shell for shielding the electrical product from electromagnetic interference. The carbon composition layer is preferably thin, for minimizing a weight of the shell and reducing costs. To be thin yet substantial enough to shield the electrical product from electromagnetic interference, the carbon composition layer has a thickness in the range of less than about 1000 nanometers. Preferably, the thickness is about 100 to about 1000 nanometers, and more preferably about 200 to about 500 nanometers. The carbon composition layer includes about 0.1% to about 10% by volume of carbon nanotubes, about 1% to about 10% by volume of carbon nanocapsules, and about 80% to about 98.8% by volume of electrically-conductive carbon black particles. The carbon black is an amorphous carbon and has irregular shape with good electrical conductivity. Each of the electrically-conductive carbon black particles has a diameter in the range of less than about 100 nanometers, and preferably about 30 to about 100 nanometers.

In the carbon composition layer, the carbon nanotubes are single-walled carbon nanotubes or multi-walled carbon nanotubes. The carbon nanotubes have a diameter in the range of several nanometers to several tens nanometers, and preferably about 2 to about 30 nanometers. The carbon nanocapsules are hollow-cored, closed polyhedrons having a nano-scaled size. Each of the carbon nanocapsules has a diameter in the range of about 20 to about 100 nanometers.

The nano-catalyst layer is formed on the carbon composition layer, and includes 5% to 90% by volume of TiO₂. The nano-catalyst layer has a thickness in the range of about 10 to about 50 nanometers, and preferably about 20 to about 40 nanometers. The nano-catalyst layer may further include a plurality of metal nanoparticles. The metal nanoparticles may be silver or gold nanoparticles, which have antiseptic and deodorizing characteristics. Each of the metal nanoparticles has a diameter in the range of less than about 5 nanometers, and preferably in the range of about 1 to about 5 nanometers.

The carbon composition layer may further include a plurality of metal nanograins added thereinto. The carbon composition layer with added metal nanograins includes less than about 10% by volume of metal nanograins, and preferably about 0.1% to about 10% by volume of metal nanograins. The metal nanograins may be silver or copper nanograins, which have excellent electrical conductivity. The metal nanograins may be filled in the carbon nanocapsules and/or carbon nanotubes. Alternatively, the metal nanograins may be mixed with the carbon nanocapsules and/or carbon nanotubes.

A second embodiment of this invention provides a process for treating a shell (e.g., a plastic shell) of a mobile phone. The process includes steps of:
(1) Providing a carbon mixture containing about 0.1% to about 10% by volume of carbon nanotubes, about 1% to about 10% by volume of carbon nanocapsules, and about 80% to about 98.8% by volume of electrically-conductive carbon black particles. The carbon nanotubes, carbon nanocapsules and carbon black particles can be made by arc-discharge or any other suitable technology. The process may further include a step of adding a plurality of metal nanograins to the mixture.
(2) Coating the carbon mixture on the shell of the electrical product using an adhesive, or by any other suitable means, to form a carbon composition layer. Typically, the adhesive is an organic or an inorganic adhesive. For example, the adhesive may be a soluble glass, ethanol, plastic resin (e.g., polystyrene, polypropylene, polyethylene, polyvinyl chloride, or polycarbonate), or a thermosetting resin (e.g., epoxy resin, phenolic resin, or unsaturated polyester resin). Various appropriate curing agents may be used with such adhesives.
(3) Coating a layer of nano-catalyst on the carbon composition layer. The nano-catalyst layer typically includes TiO₂, and may further include a plurality of metal nanoparticles.

Alternatively, the carbon mixture containing carbon nanotubes, carbon nanocapsules and electrically-conductive carbon black particles may be mixed with a base material that is used to form the shell. The mixed material is molded into a preform of the shell, and is then coated with a layer of nano-catalyst. The nano-catalyst layer typically includes TiO₂, and may further include a plurality of metal nanoparticles.

In addition to protecting the electrical product from dust, the above-described embodiments have many other advantages. First, the carbon nanotubes and the carbon nanocapsules have excellent mechanical properties (high Young's modulus), and are therefore wear resistant. Second, the nano-sized coating layers have an elaborated surface structure generating a Lotus effect, so that the surfaces of the electrical product are hydrophobic and capable of self-cleaning. Third, the electrically-conductive carbon black particles are less expensive than the carbon nanotubes and the carbon nanocapsules, thereby lowering the cost of the carbon composition layer. Fourth, the carbon composition layer shields the electrical product from electromagnetic interference, and protects the carbon composition layer from buildup of static charges. Fifth, the metal particles in the nano-catalyst layer are antiseptic and deodorizing.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

We claim:

1. A cover for protecting an electrical product from dust, the cover comprising:
a shell covering at least part of the electrical product;
a layer of a carbon composition provided on the shell, the carbon composition layer comprising:
about 0.1% to about 10% by volume of carbon nanotubes,
about 1% to about 10% by volume of carbon nanocapsules, and
about 80% to about 98.8% by volume of electrically-conductive carbon black particles; and
a layer of nano-catalyst provided on the carbon composition layer, the nano-catalyst layer comprising about 5% to 90% by volume of TiO₂.

2. The cover of claim 1, wherein the carbon composition layer has a thickness in the range of about 100 to about 1000 nanometers.

3. The cover of claim 2, wherein the carbon composition layer has a thickness in the range of about 200 to about 500 nanometers.

4. The cover of claim 1, wherein the layer of nano-catalyst has a thickness in the range of about 10 to about 50 nanometers.

5. The cover of claim 4, wherein the layer of nano-catalyst has a thickness in the range of about 20 to about 40 nanometers.

6. The cover of claim 1, wherein the carbon nanotubes are single-walled carbon nanotubes or multi-walled carbon nanotubes.

7. The cover of claim 1, wherein each of the carbon nanocapsules has a diameter in the range of about 20 to about 100 nanometers.

8. The cover of claim 1, wherein each of the electrically-conductive carbon blacks has a diameter in the range of about 30 to about 100 nanometers.

9. The cover of claim 1, further comprising a plurality of metal nanograins added in the carbon composition layer, so that the carbon composition layer added with metal nanograins comprises about 0.1% to about 10% by volume of the metal nanograins.

10. The cover of claim 1, wherein the layer of nano-catalyst comprises a plurality of metal nanoparticles each having a diameter in the range of about 1 to about 5 nanometers.

11. A cover for protecting an electrical product from dust, the cover comprising:
a layer of a carbon composition, the carbon composition layer comprising a plurality of carbon nanotubes, carbon nanocapsules, and electrically-conductive carbon black particles; and
a layer of nano-catalyst provided on the layer of carbon composition, the nano-catalyst layer comprising TiO₂.

12. A method to manufacture an electrical product, comprising the steps of:
producing a shell of an electrical product to enclose said electrical product;
attaching a first layer of composition to said shell so as to enhance ability of said electrical product against electromagnetic interference outside of said electrical product; and
coating a second layer of nano-scaled composition onto said first layer so as to enhance hydrophobic and self-cleaning ability of said electrical product.

13. The method of claim 12, wherein said first layer of composition is attached to said shell by adhesives.

14. The method of claim 12, wherein said first layer of composition is attached to said shell by mixing said first layer of composition with a base material of said shell before forming of said shell.

15. The method of claim 12, wherein said first layer of composition comprises a plurality of carbon nanotubes, carbon nanocapsules, and electrically-conductive carbon black particles.

16. The method of claim 12, wherein said second layer of composition comprises nano-scaled metal particles and TiO₂ particles.
